(19) United States
(12) Patent Application Publication
(10) Pub. No.: US 2006/0059425 A1
(43) Pub. Date: Mar. 16, 2006

(54) Method and apparatus for enabling a user to select hierarchically arranged data in a graphical user interface

(76) Inventors: Mark S. Anspach, Wellington, CO (US); Evelyn Williams, Longmont, CO (US); Kevin Wilson, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/941,223

(22) Filed: Sep. 14, 2004

(51) Int. Cl. G06F 17/00

(52) U.S. Cl. 715/713; 715/854

(57) ABSTRACT

A method of selecting options arranged in a hierarchy including a first level and at least one additional level is described. The method includes displaying a hierarchical-selection visual object. A selection action of the hierarchical-selection visual object may cause a display list, containing at least one hierarchy item and possibly selectable items, to be shown. Detecting a pointing action at a hierarchy item may cause a lower level display list to be displayed. Lower level display lists may include selectable items, hierarchy items, or both. Multiple levels of hierarchy may be displayed in this manner. With the display lists shown, a second selection action may cause the selected item to be displayed in an information area of the hierarchical-selection visual object. Other embodiments comprise a computer readable medium having stored thereon computer instructions, and a computer system for executing the computer instructions to perform the method of selecting options.

### BACKGROUND

1. Field of the Invention

The present invention relates generally to graphical user interfaces, and more particularly to a method and apparatus for allowing a user to select from a plurality of options arranged in a hierarchical manner.

2. State of the Art

Most modern computers that receive input from a user employ some type of graphical user interface (GUI). A GUI creates various visual objects or controls such as input boxes, icons, menus, toolbars, dialog boxes, buttons, and the like. The user may interact with the various visual objects by operating one or more input devices such as a keyboard, mouse, trackball, tablet, light pen, and touch sensitive screen. These visual objects may typically be pointed to and selected by using one or more of these input devices as a pointing device.

For example, by moving a mouse a user may cause a position indicator, such as a cursor, on the screen displaying the GUI to move in a manner corresponding to the mouse movement. Buttons on the mouse may correspond to different actions that the computer may perform depending on where the position indicator is located at the time a mouse button is pushed.

Different types of objects or controls may be used for different types of user input. For example, check boxes may be used to indicate a binary selection (i.e. yes/no, true/false) of a specific item or option. A text box may be used to allow a user to input a text string, perhaps from a keyboard or voice recognition. A menu item may be used to allow a user to select from a predefined set of commands to be performed. A combo box may be used to allow a user to select from a predefined set of options or to set parameters.

### SUMMARY OF THE INVENTION

An embodiment of the present invention comprises a method of selecting options arranged in a hierarchy including a first level and at least one additional level. The method includes displaying a hierarchical-selection visual object on a display. A first selection action, in which the user points to and selects the hierarchical-selection visual object, may cause a display list to be shown on the display. The display list may include at least one of a plurality of selectable items arranged on the first level of the hierarchy. Some elements of the display list in this embodiment may also include at least one hierarchy item indicating at least one additional level of hierarchy. This additional level of hierarchy may include additional hierarchy items and additional selectable items. With the display list shown on the display, a second selection action by the user of one of the displayed selectable items may cause the selectable item to be selected and displayed in an information area of the hierarchical-selection visual object.

Another embodiment of the present invention comprises a method of selecting options arranged in a hierarchy including a first level and at least one additional level as with the previous embodiment. In this embodiment, a first selection action by the user of the hierarchical-selection visual object may cause a display list to be shown on the display in which the display list contains at least one hierarchy item. Some elements of the display list in this embodiment may also include at least one selectable item. This embodiment further includes detecting a pointing action in which the user points to one of the hierarchy items, which may cause a lower level display list to be displayed. The lower level display list may include selectable items, hierarchy items, or both, which are dependent upon the hierarchy item pointed to on the display list. This pointing action to hierarchy items and display of lower level display lists may be repeated multiple times for multiple hierarchy levels. With the display lists shown on the display, a second selection action by the user of one of the displayed selectable items may cause the selectable item to be selected and displayed in an information area of the hierarchical-selection visual object.

Another embodiment of the present invention comprises a computer readable medium having stored thereon a plurality of computer instructions, which cause a computer system to perform the methods of presenting options described above.

Another embodiment of the present invention comprises a computer system including at least one pointing device, a display, a processing unit, and a storage device having stored thereon a plurality of computer instructions for execution on the processing unit which, when executed by the processor, cause the computer system to perform the methods of presenting options described above.

### BRIEF DESCRIPTION OF THE DRAWINGS

In the drawings, which illustrate what is currently considered to be the best mode for carrying out the invention:

FIG. 1 illustrates a conventional drop down menu including cascading menus to multiple levels of hierarchy;

FIG. 2A illustrates a combo box control with drop down selection;

FIG. 2B illustrates the combo box control of FIG. 2A showing a drop down list of selection options;

FIG. 3 is a block diagram of a computer system providing an operating environment for an embodiment of the present invention;

FIG. 4 illustrates a cascading combo box control according to an embodiment of the present invention;

FIG. 5 illustrates a cascading combo box control showing cascading option lists with multiple levels of hierarchy according to an embodiment of the present invention;

FIG. 6 illustrates a flow chart of a method for selecting options in accordance with an embodiment of the present invention.

### DETAILED DESCRIPTION

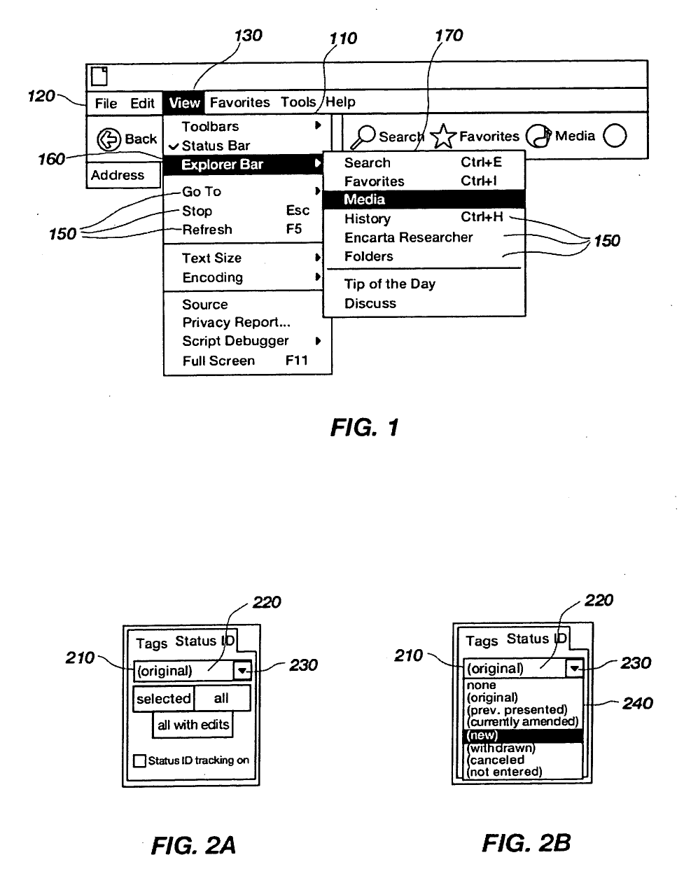

Menu items have conventionally appeared in tool bars, or as pop-up items, and generally have been used to indicate commands that may be executed if the user selects from a displayed list of the commands. For example, as shown in FIG. 1, a conventional drop down menu 110 may appear as a control at the top of a window on a tool bar 120. If a user selects a menu control 130, the drop down menu 110 of available commands is displayed. A user may point to and select any one of the displayed commands to invoke the operation associated with that command.

Drop down menus allow organization of a large number of controls, yet take up very little screen space because the control options are only displayed when the user selects the menu control. Recently, with the ever expanding number of controls available within an application program or operating system, menus have been organized in a hierarchical fashion. In other words, referring to FIG. 1, when the user selects the menu control 130, along with the display of command options 150, hierarchical options 160 may also be displayed. If the user selects one of the hierarchical options 160, an additional drop down menu 170 of available commands existing under the selected hierarchical option 160 is displayed. This additional drop down menu 170 may contain selectable command options 150 and may also contain more hierarchical options for displaying additional drop down menus. This method of displaying additional drop down menus when a hierarchical option is selected is often referred to as cascading menus.

On the other hand, combo boxes 210, as shown in FIGS. 2A and 2B, are conventionally used for allowing user input or selection of parameters that may be selected by a user and used by an application program or operating system. Combo boxes 210 are conventionally used when the user may select from a number of predefined options for the parameter associated with that combo box. For example, if a number of printers are available for printing a document, a combo box may be used to display the list of available printers from which the user may select. A combo box creates a convenient, and less error prone, way for a user to assign a value to a parameter without requiring the user to type the parameter into a text box.

Conventionally, as shown in FIG. 2A, a combo box 210 contains a text area 220 indicating the currently selected option and a drop down control 230 for displaying the option list. FIG. 2B illustrates the combo box of FIG. 2A when a user has selected the drop down control 230. In response to selection of the drop down control 230, a drop down list 240, of the available options is displayed. A user may then select one of the displayed options. Once selected, the option appears in the text area as the currently selected option. Frequently, combo boxes may also contain a default option, which is displayed in the text window before the user makes any selections. Combo boxes are typically used to set parameters before actions are taken. In contrast, menus are typically used to select from actions to perform. Conventionally, to allow a user friendly interface, parameter setting combo boxes have been relatively simple with a limited number of options or selection space. If the user may set many options, application programs have typically presented the user with a plurality of combo boxes. As a result, combo boxes, unlike command menus have not contained hierarchical lists or displayed cascading lists for selection. However, as software applications become more sophisticated and users become more comfortable with conventional combo box controls in a GUI environment, larger and more complex selection spaces are needed. Sometimes, software applications may display multiple combo boxes in a manner such that the available options in one dependent combo box are determined based on the selected option from another parent combo box. This creates a partially hierarchical selection process, but one that is cumbersome and often not very intuitive because options in the dependent combo box are not visible or available for selection until the option in the parent combo box is set.

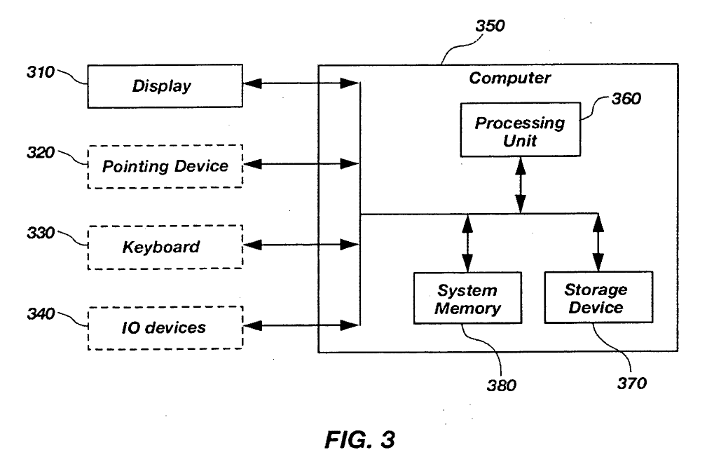

The present invention is not limited to a particular hardware system, however, an exemplary hardware embodiment is shown in FIG. 3 to show elements of a basic hardware system and help explain the operation of the present invention. The exemplary hardware includes a conventional computer 350, such as a personal computer, personal digital assistant, or workstation. The computer 350 includes, a processing unit 360, a system memory 380, and at least one storage device 370. Additional elements connected to the computer 350 may be a display 310, at least one pointing device 320, an optional keyboard 330, and other optional Input/Output (IO) devices 340.

The one or more storage devices 370, which may be coupled to the processing unit 360 and system memory 380, may be any device capable of storing data and computer instructions in a non-volatile fashion. Some of these devices may include, for example, hard disk drives, removable magnetic disk drives, flash memory devices, magnetic cassettes, and optical drives for holding optical read/writable media such as digital video disks and CD-ROM disks. The list of devices is intended to be exemplary only, other storage devices 370 are possible and contemplated within the scope of the present invention. The present invention as embodied in computer instructions and hierarchically arranged data may be stored on one or more of the storage devices 370 along with other program modules and data for other computer functions such as operating systems and application programs.

The processing unit 360 may be any unit capable of performing conventional computer instructions. There are a wide variety of processing units 360 available, as a result, the computer instructions defined to carry out the present invention may need to be configured or compiled differently for execution on different processing units 360.

The system memory 380 may include volatile and non-volatile memory elements for storing computer instructions and data. For example, the system memory 380 may include volatile memory in a combination of random access memory comprised of dynamic random access memory and static random access memory. The system memory 380 may also include non-volatile memory, such as read-only memory and flash memory. Although not required, conventionally, system memory 380 is used to allow the processing unit 360 faster access to data and computer instructions than is possible from direct access to storage devices 370. As such, data and computer instructions are often moved prior to, or during, use by the processing unit 360. The present invention as embodied in computer instructions and hierarchically arranged data may be stored in system memory 380 to facilitate access to and execution of the computer instructions and data.

The one or more pointing devices 320 may be any number of hardware interfaces capable of directing the location of a cursor displayed on the display 310 and used to point to various areas of the display 310. Some example pointing devices 320 are a mouse, a joystick, a touch sensitive tablet, a touch sensitive display screen, voice commands, and a keyboard 330. The system may be configured with multiple pointing devices 320 such that the user may choose to direct the cursor using different pointing devices 320 at different times. For example, the user may choose to move the cursor with a mouse, keys on a keyboard 330, or voice commands at different times for efficiency and convenience of the user.

Although not required, a computer 350 conventionally includes a keyboard 330 for efficient entry of alphanumeric data. Examples of computers 350 that may not include a keyboard 330 are personal digital assistants, cellular phones with computing capabilities, and special purpose computers 350 such as inventory trackers and cash registers.

Many other 10 devices 340 may be optionally included in the computer 350. Some exemplary devices are communication and network devices such as modems, local area network interfaces, and wide area network interfaces. Other optional 10 devices 340 may be devices such as printers, speakers, microphones, and cameras.

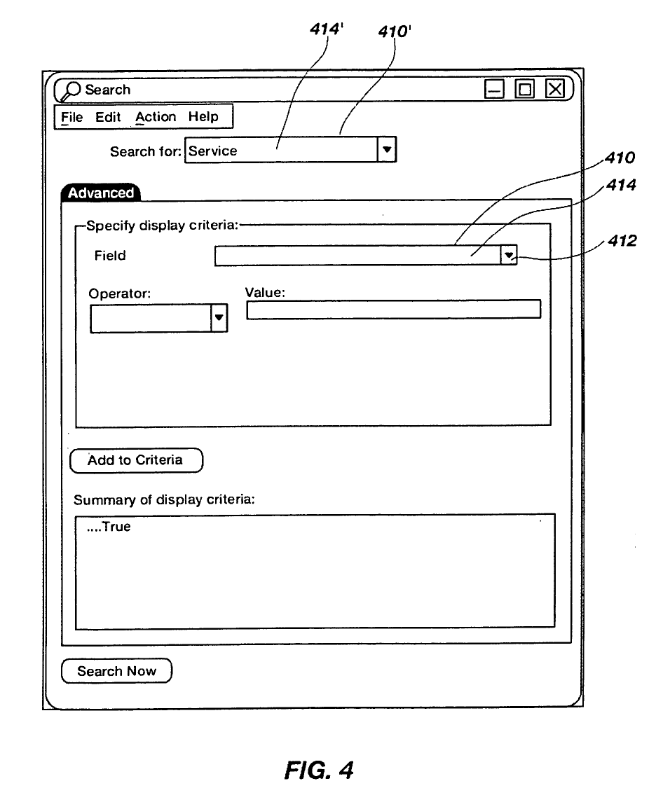

FIG. 4 illustrates a typical GUI window containing various visual objects and visual objects according to the present invention, which may be present on the display 310. A hierarchical-selection visual object (410 and 410′) (also referred to as a cascading combo box) may be initially displayed in a state waiting for input or action from a user. The hierarchical-selection visual object 410 includes an information area 414 and a cascade visual cue 412. The cascade visual cue 412 is similar to a visual cue for a conventional combo box, however the cascade visual cue 412 may contain an icon, text, or other visual cue indicating that the hierarchical-selection visual object 410 is different from a conventional combo box and may be configured to display multiple levels of hierarchy in a cascade fashion for user-selection. As shown for the hierarchical-selection visual object 410′, the information area 414′ may contain a default value, which may be the value used by the program displaying the hierarchical-selection visual object 410′ if the user does not select another alternative value.

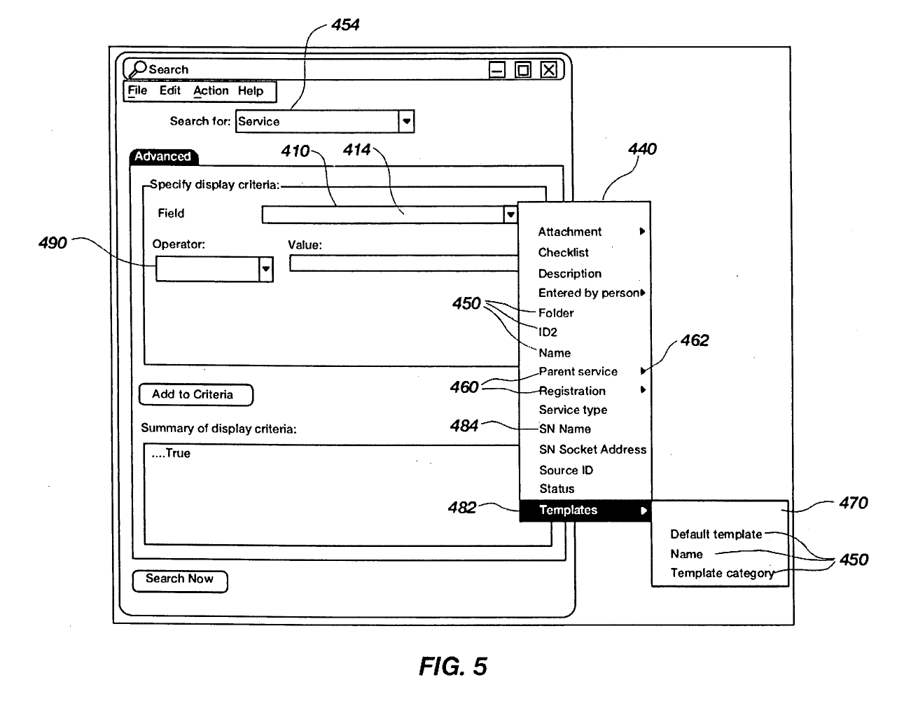

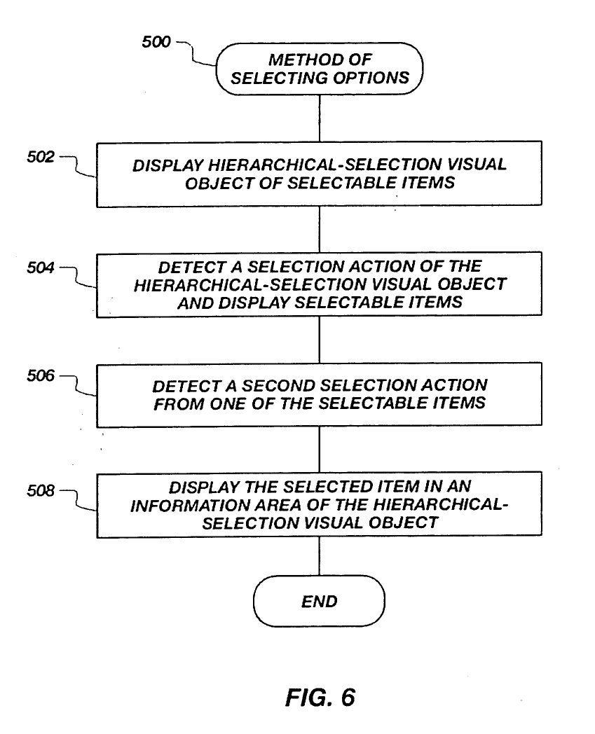

FIG. 5 illustrates a hierarchical-selection visual object 410 after the user has performed various pointing and selection actions and FIG. 6 illustrates a flow chart of a method 500 of selecting options. Conventionally, a pointing action is the process whereby the user moves the cursor to an area of the display 310 using a pointing device 320. A selection action is the process whereby the user “selects” the visual object that is currently being pointed to using some action. Selection actions may be a voice command, pressing a keyboard key, pressing a mouse button, or similar actions.

To begin operation, hierarchical the user may select the displayed 502 hierarchical-selection visual object 410. Typically, the user may perform 504 a first selection action while the cursor is pointing to the cascade visual cue 412, which may cause a display list 440 to be displayed. For many operating systems and application programs, a selection action is used rather than a pointing action because the pointing action may be reserved for displaying a pop-up hint indicating the function of the visual object currently pointed at by the cursor. However, in other systems it may be desirable for a display list 440 to be displayed when the pointing action points the cursor in the information area 414 or the cascade visual cue 412 area of the hierarchical-selection visual object 410 without requiring a selection action. As a result, depending on the system, the first selection action may be performed as a pointing action or a selection action.

The display list 440 may contain at least one selectable item 450, or at least one hierarchy item 460, or both. Selectable items 450 are items that, when pointed to and selected 506, define a new selected item 454 to be used and displayed 508 in the information area 414 of the hierarchical-selection visual object 410. On the other hand, hierarchy items 460 are items that may not be directly selectable. Rather, hierarchy items 460 may contain additional levels 470 of hierarchy, which may contain additional selectable items 450 and additional hierarchy items 460. For example, in FIG. 5, the display list 440 includes a number of selectable items 450, some of which are “Folder,” “ID2,” and “Name.” The display list 440 also includes a number of hierarchy items 460, some of which are “Parent service,” “Registration,” and “Template.” The hierarchy items 460 may include a lower level visual cue 462 indicating that additional selectable items 450, additional hierarchy items 460, or both, may be available for selection at a lower level of hierarchy 470. In FIG. 5, the lower level visual cue 462 is shown as a small triangle. However, other visual cues are contemplated within the scope of the present invention. For example, some possible visual cues may be displaying at least a portion of any text that is part of the hierarchy item 460 in a different color, displaying the background of the hierarchy item 460 in a different color, and displaying an icon different from the arrow icon. In addition, one type of lower level visual cue 462 may be used to indicate that the hierarchy item 460 includes additional levels 470 of hierarchy below, while another type of lower level visual cue 462 may be used to indicate the hierarchy item 460 includes only selectable items 450 below.

When the user performs the first selection action, the visual object comprising the display list 440 is shown on the display 310. As shown in FIG. 5, the display list 440 is to the right of, and extends below the hierarchical-selection visual object 410. However, other positioning may be used. For example, if the display list 440 might extend off the bottom of the display 310, it may be advantageous to position the display list 440 at a higher point in the display 310 such that more selectable items 450 and hierarchy items 460 may be shown. Additionally, if the display list 440 is long, the display list 440 may be configured to include a conventional scroll bar for scrolling through the entire list of selectable items 450 and hierarchy items 460. Further, it may be advantageous to position the display list 440 to the left of, or overlapping, the hierarchical-selection visual object 410. For example, if the hierarchical-selection visual object 410 is positioned on the right edge of the display 310, the display list 440 may be positioned to the left of, or overlapping, the hierarchical-selection visual object 410 because there is no room on the right side.

When the display list 440 is shown on the display 310, the user may perform pointing actions to position the cursor over one of the selectable items 450 or hierarchy items 460. In response to the cursor pointing to a selectable item 450, the present invention may use a highlighting visual cue 482 to modify the appearance of the selectable item 450. For example, the present invention may highlight, change the color, change the background, display an icon, or change the text of the selectable item 450 being pointed at by the cursor.

Similarly, in response to the cursor pointing to a hierarchy item 460, the present invention may modify the appearance of the hierarchy item 460. The appearance modification may be similar to that used for the selectable items 450, may be different from that used for the selectable items 450 to emphasize the difference between selectable items 450 and hierarchy items 460, or may not occur. Additionally, in response to the cursor pointing to a hierarchy item 460, the present invention may display a lower level display list 470 corresponding to the particular hierarchy item 460 pointed to by the cursor. This lower level display list 470 may include hierarchy items 460 and selectable items 450 that are dependent upon the pointed to hierarchy item 460. For example, in FIG. 5, pointing to the hierarchy item “Template” highlights the “Template” hierarchy item 460 and displays a lower level display list 470.

Once the lower level display list 470 is shown on the display 310, cursor movement by the user over the lower level display list 470 may use a highlighting visual cue 482 to modify the appearance of the item pointed to, in a manner similar to that described above for the display list 440. On the other hand, if the user moves the cursor to another item on the display list 440, the lower level display list 470 may be removed from the display 310 because moving the cursor away from the pointed to item indicates the user no longer desires the pointed to item. Similarly, if the user moves the cursor outside of the display list 440, the display list 440 may be removed from the display 310.

The lower level display list 470 in FIG. 5 includes only selectable items 450. However, it will be clear to a person of ordinary skill in the art that many levels of hierarchy are possible. If the lower level display list 470 included hierarchy items 460, pointing to one of these hierarchy items 460 would display yet another lower level display list 470 with selectable items 450 and possibly hierarchy items 460 dependent upon the pointed to hierarchy item 460.

As can be seen in FIG. 5, the lower level display list 470 includes an optional display list title bar 444 to reinforce to the user that the items listed in the lower level display list 470 are dependent upon the hierarchy item 460 listed in the title bar. In other embodiments, as shown for the display list 440, the display list title bar 444′ may be empty, or the display list title bar 444 may not be shown as part of the display list 440.

Typically, the selectable items 450 and hierarchy items 460 existing in the entire hierarchy of the hierarchical-selection visual object 410 may be set at the time of the first selection action. However, the selectable items 450 and hierarchy items 460 may change from one first selection action to the next first selection action. In other words, a software event or user event may modify the meaning of, or values desired for a given hierarchical-selection visual object 410. For example, in FIG. 5, a value selected for the combo box labeled “operator” 490 may change what values are desired to be presented as selectable items 450 and hierarchy items 460 in the hierarchical-selection visual object 410.

Additionally, some embodiments of the present invention may use an unavailable visual cue 484 to show some selectable items 450 or hierarchy items 460 in the display lists (440 and 470) even if they are in a state in which they may not be selectable. This may be done by showing the selectable items 450 or hierarchy items 460 in a shadowed version of text or other visual cue to indicate that while the item may be displayed it may not may not include a lower level display list 470 for a hierarchy item 460 or may not be selected for a selectable item 450.

If there are many levels of hierarchy, many display lists may be present on the display 310 as the user traverses down through the hierarchy because each display list in the hierarchical trail remains on the screen until the user makes a second selection action or a pointing action pointing away from the display lists. As a result, the present invention may present the various display lists in a substantially non-overlapping fashion taking advantage of available portions of the display 310. On the other hand, all display lists may not be able to be shown in an un-obscured fashion. In this event, the present invention may attempt to present the display lists such that at least a child display list does not obscure the parent display list even if it may need to obscure the display list of more distant ancestors.

The present invention may be implemented in one or more program modules implementing the features described herein. Additionally, the present invention is not described in any particular programming language or software implementation because it will be obvious to a person of ordinary skill in the art that the operations and procedures described herein may be practiced using any number of programming languages. Moreover, the invention may be practiced within a wide variety of operating systems and software applications executing on many different hardware platforms.

Although this invention has been described with reference to particular embodiments, the invention is not limited to these described embodiments. Rather, the invention is limited only by the appended claims, which include within their scope all equivalent devices or methods that operate according to the principles of the invention as described.

What is claimed is:

1. A method of selecting options, comprising:
displaying on a display a hierarchical-selection visual object indicating availability of a plurality of selectable items arranged in a hierarchy comprising a first level and at least one additional level;
detecting a first selection action of the hierarchical-selection visual object and thereby displaying a display list including at least one of the plurality of selectable items arranged on the first level;
detecting a second selection action of a selected item from one of the plurality of selectable items; and
displaying the selected item in an information area of the hierarchical-selection visual object.

2. The method of claim 1, wherein the display list further includes at least one hierarchy item indicating availability of the at least one additional level.

3. The method of claim 2, further comprising detecting a pointing action pointing to the at least one hierarchy item and thereby displaying a lower level display list including at least one of the plurality of selectable items that is dependent on the pointed to at least one hierarchy item.

4. The method of claim 3, further comprising hiding the lower level display list when the pointing action no longer points to the lower level display list.

5. The method of claim 3, wherein the display list and the lower level display list are substantially non-overlapping.

6. The method of claim 2, further comprising:
displaying a lower level visual cue as part of the at least one hierarchy item indicating availability of a lower level of hierarchy.

7. The method of claim 6, wherein the lower level visual cue indicates the at least one hierarchy item includes multiple hierarchy levels.

8. The method of claim 6, wherein the lower level visual cue indicates the at least one hierarchy item includes a single hierarchy level.

9. The method of claim 2, wherein the plurality of selectable items and the at least one hierarchy item further comprise a highlighting visual cue indicating when a pointing action points to each of the plurality of selectable items and the at least one hierarchy item.

10. The method of claim 2, wherein the plurality of selectable items and the at least one hierarchy item further comprise an unavailable visual cue indicating that the plurality of selectable items and the at least one hierarchy item will not respond to a pointing action or the second selection action.

11. The method of claim 1, further comprising hiding the display list when a pointing action no longer points to the display list.

12. The method of claim 1, further comprising displaying a cascade visual cue as part of the hierarchical-selection visual object indicating availability of the plurality of selectable items arranged in the hierarchy.

13. A method of selecting options, comprising:
displaying on a display a hierarchical-selection visual object indicating availability of a plurality of selectable items arranged in a hierarchy comprising a first level and at least one additional level;
detecting a first selection action of the hierarchical-selection visual object and thereby displaying a display list including at least one hierarchy item indicating availability of the at least one additional level;
detecting a pointing action pointing to the at least one hierarchy item and thereby displaying a lower level display list including at least one of the plurality of selectable items that is dependent on the pointed to at least one hierarchy item;
detecting a second selection action of a selected item from one of the plurality of selectable items; and
displaying the selected item in an information area of the hierarchical-selection visual object.

14. The method of claim 13, wherein the display list further includes at least one of the plurality of selectable items.

15. The method of claim 13, wherein the lower level display list further comprises at least one additional hierarchy item dependent on the pointed to at least one hierarchy item.

16. The method of claim 15, further comprising detecting a pointing action pointing to the at least one additional hierarchy item and displaying an additional lower level display list including at least one of the plurality of selectable items that is dependent on the pointed to at least one additional hierarchy item.

17. The method of claim 16, wherein detecting a pointing action pointing to the at least one additional hierarchy item is repeated for lower level hierarchy items that are dependent on the pointed to at least one additional hierarchy item.

18. The method of claim 13, further comprising:
displaying a lower level visual cue as part of the at least one hierarchy item indicating availability of a lower level of hierarchy.

19. The method of claim 18, wherein the lower level visual cue indicates the at least one hierarchy item includes multiple hierarchy levels.

20. The method of claim 18, wherein the lower level visual cue indicates the at least one hierarchy item includes a single hierarchy level.

21. The method of claim 13, wherein the plurality of selectable items and the at least one hierarchy item further comprise a highlighting visual cue indicating when a pointing action points to each of the plurality of selectable items and the at least one hierarchy item.

22. The method of claim 13, wherein the plurality of selectable items and the at least one hierarchy item further comprise an unavailable visual cue indicating that the plurality of selectable items and the at least one hierarchy item will not respond to a pointing action or the second selection action.

23. The method of claim 13, further comprising hiding the lower level display list when a pointing action no longer points to the lower level display list.

24. The method of claim 13, further comprising hiding the display list when a pointing action no longer points to the display list.

25. The method of claim 13, further comprising displaying a cascade visual cue as part of the hierarchical-selection visual object indicating availability of the plurality of selectable items arranged in the hierarchy.

26. The method of claim 13, wherein the display list and lower level display list are substantially non-overlapping.

27. A computer readable medium having stored thereon a plurality of computer instructions, which cause a computer system to perform a method of selecting options, comprising:
displaying on a display a hierarchical-selection visual object indicating availability of a plurality of selectable items arranged in a hierarchy comprising a first level and at least one additional level;
detecting a first selection action of the hierarchical-selection visual object and thereby displaying a display list including at least one of the plurality of selectable items arranged on the first level;
detecting a second selection action of a selected item from one of the plurality of selectable items; and
displaying the selected item in an information area of the hierarchical-selection visual object.

28. A computer readable medium having stored thereon a plurality of computer instructions, which cause a computer system to perform a method of selecting options, comprising:
displaying on a display a hierarchical-selection visual object indicating availability of a plurality of selectable items arranged in a hierarchy comprising a first level and at least one additional level;
detecting a first selection action of the hierarchical-selection visual object and thereby displaying a display list including at least one hierarchy item indicating availability of the at least one additional level;
detecting a pointing action pointing to the at least one hierarchy item and thereby displaying a lower level display list including at least one of the plurality of selectable items that is dependent on the pointed to at least one hierarchy item;
detecting a second selection action of a selected item from one of the plurality of selectable items; and
displaying the selected item in an information area of the hierarchical-selection visual object.

29. A computer system, comprising:
at least one pointing device;
a display;
a processing unit coupled to the display; and
a storage device having stored thereon a plurality of computer instructions for execution on the processing unit which, when executed by the processing unit cause the computer system to perform a method of selecting options, comprising:
displaying on a display a hierarchical-selection visual object indicating availability of a plurality of selectable items arranged in a hierarchy comprising a first level and at least one additional level;
detecting a first selection action of the hierarchical-selection visual object and thereby displaying a display list including at least one of the plurality of selectable items arranged on the first level;
detecting a second selection action of a selected item from one of the plurality of selectable items; and
displaying the selected item in an information area of the hierarchical-selection visual object.

30. A computer system, comprising:
at least one pointing device;
a display;
a processing unit coupled to the display; and
a storage device having stored thereon a plurality of computer instructions for execution on the processing unit which, when executed by the processing unit cause the computer system to perform a method of selecting options, comprising:
displaying on a display a hierarchical-selection visual object indicating availability of a plurality of selectable items arranged in a hierarchy comprising a first level and at least one additional level;
detecting a first selection action of the hierarchical-selection visual object and thereby displaying a display list including at least one hierarchy item indicating availability of the at least one additional level;
detecting a pointing action pointing to the at least one hierarchy item and thereby displaying a lower level display list including at least one of the plurality of selectable items that is dependent on the pointed to at least one hierarchy item;
detecting a second selection action of a selected item from one of the plurality of selectable items; and
displaying the selected item in an information area of the hierarchical-selection visual object.

31. An interface for selecting options, comprising:
a means for displaying on a display a hierarchical-selection visual object indicating availability of a plurality of selectable items arranged in a hierarchy comprising a first level and at least one additional level;
a means for detecting a first selection action of the hierarchical-selection visual object and thereby displaying a display list including at least one of the plurality of selectable items arranged on the first level;
a means for detecting a second selection action of a selected item from one of the plurality of selectable items; and
a means for displaying the selected item in an information area of the hierarchical-selection visual object.
